(19) United States
(12) Patent Application Publication
(10) Pub. No.: US 2002/0152180 A1
(43) Pub. Date: Oct. 17, 2002

(54) System and method for performing secure remote real-time financial transactions over a public communications infrastructure with strong authentication

(76) Inventor: Paul Turgeon, Fort Collins, CO (US)

Correspondence Address: GOODWIN PROCTER & HOAR LLP, 7 BECKER FARM RD, ROSELAND, NJ, 07068, US

(21) Appl. No.: 10/086,793

(22) Filed: Mar. 1, 2002

Related U.S. Application Data
(63) Continuation-in-part of application No. 09/394,143, filed on Sep. 10, 1999.

(51) Int. Cl. G06F 17/60

(52) U.S. Cl. 705/72

(57) ABSTRACT

There is provided a system and method for providing a payment service including processing a payment service request having independent identification information and a pair of ATM network compatible PINs, including validating the independent identification information and generating an ATM network transaction message containing at least a selected one of the pair of ATM network compatible PINs based at least in part on said validating step; and forwarding the ATM network transaction message to a financial institution over an ATM network for payment. The system and method may also include providing a data storage device for interacting with a network access device where the data storage device has the pair of ATM network compatible PINs stored thereon; and each one of the pair of ATM network compatible PINs is independently encrypted and different from one another. The system and method of the present invention may further provide for generating the payment service request including the pair of ATM network compatible PINs and independent identification information.

### RELATED APPLICATIONS

This application is a continuation-in-part and claims the benefit of co-pending U.S. non-provisional patent application Ser. No. 09/394,143 filed on Sep. 8, 1999 entitled “System and Method for Providing Secure Service Over Public and Private Networks Using a Removable Portable Computer-Readable Storage Medium at a Network Access Drive.”

### TECHNICAL FIELD OF THE INVENTION

The present invention generally relates to performing secure, authenticated real-time financial transactions over a public access network.

### BACKGROUND OF THE INVENTION

The demand for secure, authenticated real-time funds transfer between two remote entities over a public access network has increased tremendously with the increased use of the Internet as a commerce platform. As an increasing number of Internet users are attracted to the conveniences and advantages of on-line shopping and on-line banking, web merchants and financial institutions are finding a need to address several crucial issues concerning e-commerce. Both are intent on attracting a greater number of customers to their product and service offerings and both need secure and convenient mechanisms for performing commerce activities that protect their respective investments and customer goodwill.

First and foremost is a need for appropriate security to protect transaction information and the parties involved in e-commerce transactions. In a typical e-commerce transaction, the parties to the transaction (consumer, merchant, and financial institution) each have a need to be confident in who they are transacting with (authentication), to know that the parties and financial resources are eligible and available to transact the particular business (authorization), and that the sensitive information shared during the transaction is kept private and inaccessible to all but those requiring the information to conduct the business (data security). Due to the less than robust nature of today's e-commerce transaction offerings, transaction fraud, repudiation and charge-backs are contributing to transaction costs that far exceed those of the traditional physical world transaction mechanisms. Merchants and financial institutions are bearing these costs in a rush to gobble up new businesses in the world's fastest growing marketplace but the consumer is hesitant to participate in this arena, knowing the increased risks of transacting “on-line” as reported frequently in the media. To capture these hesitant consumers and entice them to conduct on-line transactions without reservation requires an e-commerce transaction mechanism that feels safe and assures them that their confidential information will not be intercepted and misused by fraudulent users or by an unscrupulous merchant.

Convenience and ease of use are also very important in any consumer offering and represent a second key challenge relating to on-line purchases. Web merchants need websites that are user-friendly for e-commerce transactions, allowing even a novice computer user to purchase goods and/or services with minimum experience and knowledge. In addition, the amount of effort expended on a transaction is likely to be directly proportional to the customer's attention span and time. Customers have to be enabled to do a transaction quickly on a website because of today's fast-paced environment, or the web merchant risks losing that customer.

Currently, to make a purchase over a public access network, merchant web sites require purchasers to complete long forms that provide personal and payment instrument information on-line. It is not uncommon for customers to fill in a form consisting of several pages. To enter all the requested information, the customer can scroll down to see the entire form or go to another page for continuation. In addition, if one of the requested items of information, such as name, address, e-mail address, phone numbers, etc., is accidentally skipped by the customer, he is required to return to the form to add the missing information. Furthermore, entering the information on-line is subject to typographical errors causing problems for web merchants and customers alike.

Furthermore, the conventional web merchant site offers an option of phoning in credit or debit card information if the customer does not feel safe in providing this information on a public access network. Such an option, however, partially defeats the advantages enjoyed by the merchant in selling goods and/or services over the Internet. Attending to customer information supplied over the phone is not only time-consuming, but requires the web merchant to have staff for manning the phones and to maintain a sufficient number of lines. The additional expense for the web merchant and other attendant problems, such as forgetting to phone in the credit or debit card information, for example, present additional disadvantages of the current systems and techniques for performing electronic transactions over the Internet using a personal computer without having to provide additional hardware.

Other systems, such as smart cards also allow for providing a customer's information without entering in pages of personal information over the Internet. These systems use additional specialized hardware, such as a card reader, wherein the customer swipes the card across a reader to have his card having a magnetic stripe or embedded chip read. Such a system allows a customer to avoid the trouble of completing a long form. However, specialized hardware for reading the card is necessary to effectuate such a transaction.

The present invention solves these and other problems by providing a convenient and portable way to make real-time PIN-secured purchases on a public access network, such as the Internet, with funds drawn directly from deposit accounts. The present invention also provides a novel and unique system and method for debit payments that can be used with a standard PC with a CD-ROM drive, without requiring a user to install any special hardware, such as a card reader. The present invention works just like an ATM card over a public access network, such as the Internet.

### SUMMARY OF THE INVENTION

It is an object of the present invention to provide a system and method for performing secure real-time financial transactions over a public access network where authentication of the consumer can be validated by the financial institution using two separate authentication factors (tokens), something possessed (the card) and something known (the e-PIN).

It is another object of the present invention to provide a system and method for providing a payment service including processing a payment service request having independent identification information and a pair of ATM network compatible PINs, including validating the independent identification information and generating an ATM network transaction message containing at least a selected one of the pair of ATM network compatible PINs based at least in part on said validating step; and forwarding the ATM network transaction message to a financial institution over an ATM network for payment. The system and method may also include providing a data storage device for interacting with a network access device where the data storage device has the pair of ATM network compatible PINs stored thereon; and each one of the pair of ATM network compatible PINs is independently encrypted and different from one another. The system and method of the present invention may further provide for generating the payment service request including the pair of ATM network compatible PINs and independent identification information.

It is yet a another object of the present invention to provide a data storage device having a data structure stored thereon, wherein the data storage device, used by an application program, is structure characterized by a plurality of data fields stored thereon, wherein at least some of said data fields contain segments of data representing information relating to financial transactions; and the data fields are arranged in a predetermined sequence so that data representing information relating to financial transactions can be obtained by selecting one of two or more subsets of the data fields in a respective predetermined order.

It is yet a further object of the present invention to provide a system and method for providing a payment service including a data storage device to a user for interacting with a network access device connected to a network; wherein the data storage device has a pair of encrypted ATM network compatible PINs and an primary account number (PAN) stored thereon; a payment service request including said pair of encrypted ATM network compatible PINs, said PAN and an electronic personal identification number (e-PIN); a processor; where the payment service request is received at a location remote from said network access device; a payment service message is generated at the location remote from the network access device by adding an amount, and a payee to the pair of encrypted ATM network compatible PINs, the PAN and the e-PIN; the payment service message is transmitted over an ATM network switch to said processor and processed at the processor by decrypting at least some of the encrypted information and determining if the e-PIN is proper to generate and communicate a message from the processor to the user's bank resulting in debiting of user's bank account electronically substantially in real-time including generating a digital ATM network transaction message containing at least a selected one of the pair of ATM network compatible encrypted user PINs and the amount and applying the message to the ATM network; and authorizing payment to the payee.

Further features and advantages of the present invention as well as the structure and operation of the preferred embodiments of the present invention are described in detail below with reference to the accompanying drawings. In the drawings, like numbers indicate identical or functionally similar elements.

### BRIEF DESCRIPTION OF THE DRAWINGS

Exemplary aspects of the present invention will now be described, by way of example only, with reference to the accompanying drawings, in which:

FIG. 1 is an exemplary block diagram that depicts the structure of the system embodying the present invention.

FIG. 2 is an exemplary flow diagram that depicts the card issuance process.

FIG. 3 is an exemplary detailed diagram of the card issuance process.

FIG. 4 is an exemplary conceptual schematic layout of the e-commerce card contents.

FIG. 5 is an exemplary flow diagram of the development of the e-commerce card data.

FIG. 6 is an exemplary flow diagram for generating an active web component transaction request message and receiving an active web component authorization response.

FIG. 7 is an exemplary flow diagram for a merchant payment module transaction request and response message.

FIG. 8 is an exemplary detailed flow diagram for an Internet intercept processor processing an exemplary transaction request message and receiving a response message.

### DETAILED DESCRIPTION

The present invention is directed to a system and method for providing real-time PIN-secured purchases over a public access network, such as the Internet, with finds drawn directly from deposit accounts. The present invention includes a system and method for providing secure financial services over public communication lines, such as the Internet, intranet or any other network, using encrypted information on a removable, portable storage medium, such as a CD-ROM. In one aspect of the present invention, information relating to a customer's bank account is stored on a disk, which becomes his e-commerce debit card. For each customer, the stored information may include a customer's name, name and routing number of an issuing bank or financial institution, customer's account number, etc. This information is encrypted prior to being stored on the disk. Disks with the encrypted information are distributed to associated customers for use in debit purchases over the Internet.

In use, consumers can purchase goods or services from Internet merchants through the use of the e-commerce card and an e-PIN much like they do at a physical world point of sale (POS) merchant today. The e-commerce card may take the form of a CD-ROM that has been altered to conform to a debit card shape through the use of a laser cutting process. The resulting medium is familiar to the consumer in shape, easy to transport from computer to computer, and durable in nature. Capable of being used by any computer with a CD-ROM drive, the e-commerce card provides a ubiquitous payment medium to the consumer. No special hardware or card reading equipment is required for Internet access.

The e-PIN is a personal identification number (PIN) provided to the consumer, and is associated with the account information on the CD-ROM. The e-PIN is provided to ensure that when transacting over a public access network, such as the Internet, a different PIN than in the real world (as in when a customer stands at an ATM machine, inserts an ATM card and then inputs the appropriate PIN to receive money) is used. The e-PIN is entered by the customer at a keyboard or other input device associated with a network access device, like a personal computer.

Because the cardholder data is pre-loaded and read from the CD-ROM, it alleviates the need for the consumer to fill out on-line payment data forms as is necessary for credit card transaction processing today. Typical on-line web forms are difficult to complete, requiring total accuracy from the consumer during the entry of sensitive data that may endure on the access device (i.e. PC) after the purchase has been completed. Additionally, a great deal of trust on the part of the consumer is required considering that all of the data will be transmitted “in the clear” to an unknown merchant on the web. By contrast, the present invention delivers all necessary data in a secure fashion, automatically when consumers place the present e-commerce card in the CD-ROM drive. Sensitive cardholder information is hidden from the merchant via state of the art encryption schemes and data obfuscation techniques, shielding the consumer and their financial institution from the possibility of fraudulent or unscrupulous web merchants.

The contents of the e-commerce card of the present invention may include information traditionally found in the track data of today's magnetic stripe debit cards. This critical data, which is “in the clear” on exiting debit cards can be highly encrypted on the present e-commerce cards, using, for example, 3DEA cryptography with issuer keys. If lost, the card is of little use to an unauthorized user without the e-PIN. Extracting actual cardholder data from the card is not worth the effort, given the robust nature of 3DEA. The present e-commerce cards may also contain data to facilitate transaction routing during delivery to the debit network as well as a bank selected audio message and a visual screen for the consumer. The audio/visual contents can be presented to the consumer during each purchase, providing the financial institution with an opportunity to strengthen its relationship with deposit holders by promoting its presence.

The present invention is an improvement over SET or Digital Certificates. In both cases, the merchant is confronted with onerous key management and security requirements that create operational overhead and represent deployment problems. Both also require significant infrastructure changes. The present invention alleviates these and other problems by performing all encryption and decryption processing where it makes most sense, within the systems that are already in place to handle cryptographic keys from a processing and operational standpoint; the debit networks. Relieving the merchant from this burden during processing make the present invention easy to implement and maintain.

Additionally, merchants can save due to reduced transaction processing fees and a significant decrease in chargebacks. The use of a secure PINned debit solution can reduce fraud and accelerate payment for goods and services. The incidence of incorrect consumer information due to key entry errors may be nearly eliminated.

Provided next are descriptions of some terminology to assist in understanding of the present invention:

PAN: Primary Account Number. The number that uniquely identifies the card used by the consumer to effect a financial transaction. The number follows industry standard requirements, is used to route the transaction from the merchant to the issuer, and is used during the authentication process with other transaction or stored elements to validate the PIN supplied by the customer during a financial transaction.

IIP PAN: A fabricated value which, when mathematically combined with the e-PIN using an industry standard PIN validation algorithm, can be used by processor to validate the quality of the supplied e-PIN and card data, effectively authenticating the individual performing a financial transaction. The IIP PAN is preferably a 64 bit value.

Pseudo-PAN: A unique customer identification number used solely for transaction logging and routing that conforms to the industry standard ISO requirements for a PAN. Merchants may also, optionally, use this number for MIS transaction trend analysis since it is in the form of a PAN. The Pseudo-PAN is not itself used to fabricate valid purchase or payment instructions.

System ISO 8583: A guideline for Message Structures, Flows and Processing Requirements defined by the present invention to enable Internet on-line transaction activities using the existing Debit Card Network infrastructure.

Confirmation/Order Number: A transaction receipt/reference number, the format of which is proprietary to the merchant.

e-PIN offset: A mathematical value derived from the combination of the IIP PAN, an issuer 3DEA Key, and the e-PIN which can be used during transaction processing to validate the quality of the e-PIN supplied by the consumer initiating the transaction.

BIN: Bank Identification Number; the initial digits of a payment card PAN that identify the issuing bank (the customer's bank) for routing and transaction processing purposes.

BLOB: Binary Large Object. A binary encoded cryptogram that contains the traditional contents of a plastic payment card as well as additional proprietary data elements used in processing financial transactions within the system defined by the present invention.

CLOB: Character Large Object. A hexadecimal representation of the binary data extracted from the BLOB during transaction processing.

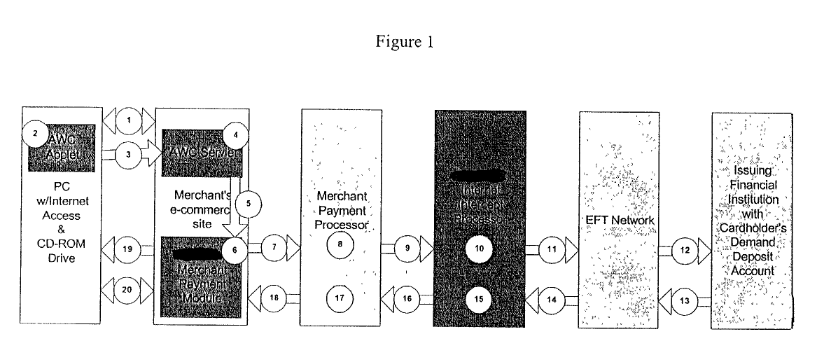

Referring now to the drawings, FIG. 1 is a block diagram illustrating an exemplary aspect of the present invention. In this aspect, the present invention may include an Active Web Component (AWC), a Merchant Payment Module (MPM), and Internet Intercept Processor (IIP), a Card Issuance Process (CIP), and a Hardware Security Module (HSM).

Terminology used throughout the specification is not meant to be limiting in any way. Instead, such terms should be referred to their descriptive meaning. In addition, such terminology is provided merely for ease of reading.

The AWC is a software module residing on a server having an associated servlet and applet for collecting and forwarding data from a network access device to the server. The AWC collects payment tokens from the consumer, presents branded audio and graphic displays to the consumer and presents a unique request message to the merchant for each transaction. The AWC can be deployed on the merchant's web server or a merchant selected service provider in object code only so that the merchant and/or the service provider cannot read or modify the software module. An AWC Servlet for each merchant, in for example C, C++ or Java, is provided. In addition multiple AWC Applets to support the different consumer computer operating environments, for example, Windows 98 or Mac OS 9, are also provided.

The Active Web Component Applet may be stored on and provided to consumer's browsers via the merchant's web server. Once supplied to the browser, the AWC Applet controls interactions between the AWC Servlet and the consumer's browser. It manages collection of card data and directs consumer activity. When the AWC closes, control is returned to the merchant's web server. Due to embedded message assembly schemes, AWC components may be supplied to merchants or merchant service providers in object code only so as to prevent fraud. Each AWC Servlet carries a unique license number, providing an audit trail in the event of duplication fraud.

The MPM formats and submits transaction requests, processes transaction responses and performs exception processing. The MPM may be deployed on the merchant e-commerce server. In most cases, an enhancement to existing vendor supplied merchant payment software can be used to provide all of the MPM required functionality. In addition, code can be developed at the discretion of the independent software developer, such as in Perl, C, C++, Java, or UNIXMacros.

The MPM runs in conjunction with an SSL enabled web server on the merchant web site. It facilitates interactions between the Merchant Payment Processor and the merchant's current e-commerce site. The MPM collects transaction requests from the consumer (via the AWC) and the merchant storefront, prepares those requests for transmission, and then forwards them to the Merchant Payment Processor. Additionally, it serves the same function for responses returned by the Merchant Payment Processor.

The IIP decrypts the payments tokens, validates the e-PIN, translates the Legacy tokens, formats standard network POS messages and warehouses delayed and recurring payment tokens. The IIP operates in an issuer or trusted agent (Network) platform. The IIP functionality may be provided via enhancements to an existing Network interface and/or an independent data processing platform.

The IIP receives messages from the Merchant Payment Processor, parses and decrypts those messages, and then reformat them into ISO 8583 messages acceptable to an Electronic Funds Transfer (EFT) Network. The IIP receives response messages from the Network, appends data needed by the merchant web site, and transfers those messages to the Merchant Payment Processor.

An exemplary transaction flow from an overview perspective involved in transmitting and processing a transaction is shown in FIG. 1 and is further described below.

Referring again to FIG. 1, which is a block diagram of the system including an exemplary transaction providing a secure manner to acquire PINned ATM/POS debit requests from a public communication network. First, a consumer selects the icon on the personal computer representing a debit transaction for purchasing the desired goods or services. In response, as shown as step 101, an AWC Applet is downloaded to the consumer's PC over a secure SSL session. Next, at step 102, the AWC Applet prompts the consumer for his electronic debit card. The consumer places the card into the CD-ROM drive associated with the PC and the AWC Applet reads and displays the Financial Institution message from the card, prompts the consumer to enter his e-PIN, and reads the encrypted data from the card in a unique manner. At step 103, the AWC Applet sends a transaction request message to the AWC Servlet via an SSL link. At step 104, the AWC Servlet receives the incoming request from the Applet and reformats it for delivery to the Merchant Payment Module (MPM). At step 105, the AWC Servlet actually sends the message to the MPM. The AWC Applet terminates and returns control to the Merchant web server.

Once the MPM receives the message from the AWC Servlet, it appends the merchant specific data and transaction amount to the transaction request, indicated as step 106. Next, as shown in step 107, the MPM delivers the transaction request to the Merchant Payment Processor (MPP) in a format agreeable to both parties. The MPP then reformats the message into a System ISO 8583 request message in step 108. After reformatting, in step 109, the MPP delivers the System ISO 8583 request message to the IIP located at an EFT Network.

Once the IIP receives the message, in step 110, the IIP processes it. The IIP process the message by verifying the message contents, decrypting the cardholder Legacy tokens, validating the e-PIN, translating the correct Legacy PIN Block and formatting a network defined ATM/POS request. The IIP then forwards the Legacy system ATM/POS message to the correct EFT Network Switch for processing just and any other ATM/POS request, as shown in step 111. Then, in step 112, the EFT Network Switch delivers the request to the appropriate Issuer over an existing link. In step 113, once the Issuer receives the message, it returns and authorization to the EFT Network Switch via the host link. The EFT Network Switch delivers the authorization response to the IIP in the Network's message format, as shown in step 114.

When the IIP receives the authorization response message from the EFT Network Switch, it constructs a System ISO 8583 response message by replacing the return Legacy PAN with the Pseudo-PAN and adding the consumer demographics, as represented in step 115. The IIP then delivers the newly constructed System ISO 8583 response message to the MPP in step 116. Upon receipt, the MPP reformats the response for the MPM in their agreed upon format and then forwards the response to the MPM, as shown in steps 117 and 118, respectively. The MPM hands the response to the merchant web server for display of the shipping information to the consumer, in step 119. Finally, the consumer verifies the shipping address and purchase amount and accepts the transaction and the merchant website provides the consumer with a final receipt in step 120.

During steps 106 through 109 and 116 through 118, the Pseudo-PAN is the settlement element. During steps 110 and 115 both the Pseudo-PAN and Legacy PAN are known. While, during steps 101, 102, 103, 104, 119 and 120, neither PAN is exposed.

A more detailed description of an exemplary transaction provided in FIG. 1 is described below.

Step 101: Select Payment Method

A consumer selects e-commerce debit as the payment method. An SSL session is established and an AWC Applet is downloaded to the consumer's browser from the merchant web server.

Step 102: Enter Card and E-Pin

The AWC Applet prompts the consumer to place the e-commerce card in the CD-ROM drive; reads and displays the Financial Institution message; prompts the consumer to enter their alphanumeric e-PIN; and reads the encrypted data from the card.

If a consumer does not place a card in the CD-ROM drive or places it in the drive improperly, the Active Web Component can manage such “card not found” situations. For example, after the consumer is prompted by a Display Class/Component to insert his e-commerce card, a dialog box provides a modal selection (e.g. OK or Cancel). When OK is selected, a CD-ROM I/O Class checks for the presence of the card. If it is not detected, the CD-ROM I/O notifies the Display Class/Component. The Display Class/Component again prompts the consumer to insert the card. This loop continues until either the card is detected or the consumer clicks the Cancel button. When Cancel is selected, the AWC can point the browser to a System-sponsored web address where the consumer can submit a request for an e-commerce card. If desired, the provider can then contact the financial institution on behalf of the consumer, and notify the issuer of the consumer's request.

Step 103: Payment Token Transmission to AWC Servlet

The AWC Applet sends a transaction request message to the AWC Servlet via an established SSL link. The AWC converts the BLOB data to a CLOB format. Character format provides ease of transmission over a public access network, such as the Internet. However, other data formats may be acceptable, as well.

Step 104: AWC Servlet Prepares Request for MPM

The AWC Servlet receives the incoming request from the Applet and formats it for delivery to the MPM.

Step 105: Request Delivery to Merchant

The AWC Servlet forwards the message to the MPM at the merchant web site. The AWC Applet terminates and returns control to the merchant's web server.

Step 106: Append Merchant Data

The MPM appends merchant specific transaction data to the transaction request.

Step 107: Forward to Processor

The MPM sends the transaction request to the Merchant Payment Processor (MPP). The transaction may be delivered in any format agreeable to both MPM and MPP, and contains the transaction data elements of the present invention.

Step 108: Create ISO Request

The Merchant Payment Processor reformats the message as a System ISO 8583 request message.

Step 109: Submit Request to Up

The Merchant Payment Processor forwards the properly formatted request to the IIP, which may be located at an EFT network.

Step 110: IIP Processing

The IIP) verifies the incoming message, authenticates the consumer and decrypts the cardholder's legacy system payment tokens. It constructs an ATM/POS request message in the format of the EFT Network to which it is connected.

Step 111: IIP Routes to Network

The IIP forwards a legacy ATM/POS request message to the correct EFT Network switch for processing.

Step 112: Network Routes to Issuing Financial Institution

The EFT Network switch delivers the transaction request to the issuing Financial Institution for authorization, using an existing host link.

Step 113: Issuer Authorization Returned

The issuing Financial Institution returns an authorization response to the EFT Network switch, via an existing host link.

Step 114: Network Returns Response

The EFT Network switch delivers the authorization response to the IIP.

Step 115: IIP Processes Network Response

The IIP constructs a System ISO 8583 response message from the EFT Network authorization response adding consumer demographic information that was stored from the decryption of the original request.

Step 116: IIP Sends Response

The IIP delivers the authorization response and shipping information to the Merchant Payment Processor in the form of a System ISO 8583 response message.

Step 117: MPP Response Preparation

The Merchant Payment Processor reformats the response into the format shared by the MPM and MPP.

Step 118: Merchant Receives Response

The MPP forwards the response to the MPM.

Step 119: Consumer Views Response

MPM hands the response to the merchant web site for display of the shipping information to the consumer.

Step 120: Consumer Confirms Address & Receipt

The consumer verifies the shipping address and transaction amount, and accepts or denies the transaction. The merchant web site provides the consumer with a receipt.

The issuing Financial Institution may deny the transaction request for a variety of reasons, including insufficient funds, invalid account, expired card, etc. When an authorization request is denied or otherwise rejected, the merchant web site would provide the consumer with enough information to ascertain why the transaction was denied, or not completed. In those instances where a specific reason cannot be given, the merchant web site shall refer the consumer to the issuing Financial Institution.

Turning next to the Card Issuance Process (CIP). The CIP prepares the Legacy cardholder tokens and data for the system, populates individual cards and prepares and sends e-PIN mailers to the customers. The CIP environment includes an issuer or trusted agent and a certified card production facility, such as Visa® or Master Card®. The CIP components include a Data Preparer, a Data Padder and a Card Production facility.

Security measures are provided to mitigate risks such as unauthorized use, remote duplication, theft of consumer account information or demographics, capture and replay of a transaction by unscrupulous entities, use of captured data to fabricate “white plastic” and capture of consumer payment tokens via website compromise. The security measures include a two token authentication requiring the use of a card and an e-PIN. In addition, all cardholder Legacy tokens can be encrypted in multiple layers of industry standard cryptography such as 3DEA. Moreover, Track-2 information supplied to Acquirer platforms can be limited to routing only, and not transactions. Furthermore, each transaction has encrypted payment tokens scrambled in a unique, time-sensitive manner. Other security measures provided may include the following: not having the Legacy PIN Blocks and e-PIN validation data available outside an HSM; deploying the AWC Applet with no knowledge of the card and/or data; having the AWC Applet ensure that the cardholder's card is not left in the CD-ROM drive; and requiring that remote card duplication can only be accomplished through the coordinated theft of over 16 MB of unique card data and dependent upon use of the e-PIN. Additional security measures may provide that the cards are not embossed with any information that uniquely identifies a consumer; fraud criteria to flag suspicious transactions; and automated e-mail identifying each card use to the cardholder.

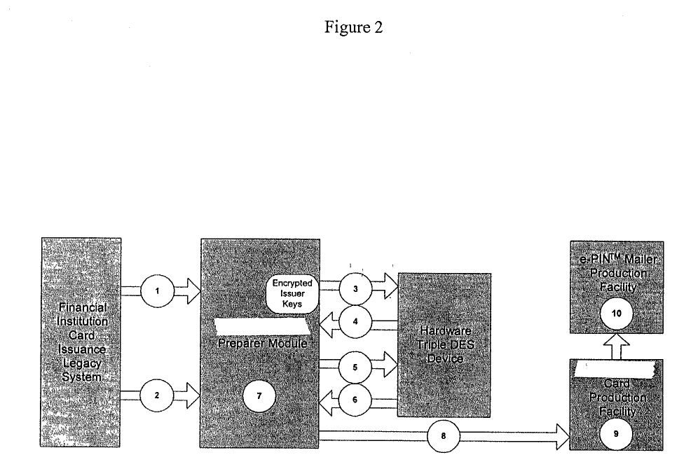

Referring now to FIG. 2, an overview of an exemplary CIP facility, including a Financial Institution card management system; a Data Preparer Module; a 3DEA capable Hardware device enabled with custom System defined cryptographic calls; a Card Production Facility; and an e-PIN mailer production facility.

Part of the CIP is a Data Preparer Module (DPM). This module builds the data files necessary for physical card issuance. It uses the data streams provided by the issuing financial institution to create the content of the e-commerce card of the present invention. The card content may go through three rounds of encryption and data scrambling before being delivered to a card production facility. Issuers submit four sets of keys for use by the DPM and 3DEA enabled hardware device, referenced below as Key A,B,C, and D respectively. Theses keys are used in card production and are store by the IIP in an encrypted form for later use during transaction processing.

Also part of the CIP is the Card Production Facility (CPF). This is the secure, physical location where the individualized data needed for the each e-commerce card is stored on it through a typical media preparation process.

As shown in FIG. 2, the Card Issuance Process is illustrated as an exemplary aspect of the present invention.

Step 201: Receive Card Data

The embossing and encoding file, created by the financial institution's card management system, is sent to the CIP Data Preparer Module.

Step 202: Receive Pin and E-Pin Data

Data for calculating and/or encrypting PIN values and for creating an e-PIN is delivered from the Issuer to the Data Preparer Module. Following secure procedures, Issuer keys, including the 3DEA Keys A, B ,C, and D are delivered and entered to the Data Preparer Module.

Step 203: Encrypt Pin and E-Pin Data

The Data Preparer Module (DPM) sends the legacy system PIN block values (or calculates them if not provided by issuer) to the 3DEA enabled Hardware Device for encryption, using the financial institution's key and 3DEA Key A. Both a valid and an invalid PIN block value are provided. In a separate call, the e-PIN, IIP PAN, and 3DEA Keys B and C are sent to the 3DEA Hardware Device to be used the custom System defined cryptographic call. The call calculates the e-PIN Offset using the supplied data and 3DEA Key B, and additionally encrypts the e-PIN Offset and the IIP PAN into a single cryptogram using 3DEA Key C.

Step 204: Return Calculated Pin & E-Pin Data to the DPM

The 3DEA enabled Hardware Device returns three cryptograms to the Data Preparer Module for use in the System. The first is a valid issuer PIN block encrypted under Key A, which when supplied to an issuer during transaction processing in the System, will cause the issuer to positively authenticate the consumer. The second is an invalid issuer PIN block encrypted under Key A, which when supplied to the issuer during transaction processing in the System, will cause the issuer authentication test to fail for incorrect PIN supplied by the consumer. The final cryptogram, referred to as the e-PIN Validation Block contains the encrypted representation of the e-PIN Offset and the IIP PAN collectively encrypted under Key C. This block is used to validate the quality of the e-PIN supplied by the consumer during transaction processing in the System.

Step 205: Data Combination and Final Encryption

The Data Preparer Module combines the encrypted issuer valid PIN block, invalid PIN block, e-PIN Validation Block and other encoding data, including the customer's demographic information and statement address into a single data element. This data element is sent back to the 3DEA enabled Hardware Device for a final round of encryption, using 3DEA Key D to create a single cryptogram.

Step 206: Return the Blob to the DPM

The resulting single cryptogram containing multiple elements encrypted under all four of the issuer supplied 3DEA Keys is referred to as the BLOB. The BLOB is returned to the Data Preparer Module for subsequent use in the Card Issuance Process.

Step 207: Create Card Production File

The Data Preparer Module creates the card production file, which includes a unique Pseudo PAN, e-PIN mailing instructions in clear text, a card capabilities file in clear text that is used during transaction processing in the system, the unique BLOB, the e-PIN, and the financial institution's visual and audio message for each System compliant card to be produced.

Step 208: Transmit Card Production File

The Data Preparer Module sends the card production file to the Card Production Facility in a properly secured manner.

Step 209: Personalize Cards

The Card Production Facility writes the data on the e-commerce cards, using specially prepared CD-ROM media and industry standard CD-ROM production equipment. In one aspect of the present invention, there is no consumer data printed anywhere on the exterior of the card.

Step 210: Produce and Send E-Pin Mailers

The e-PIN Mailer Production Facility creates the e-PIN mailers using the supplied e-PIN mailing instructions supplied in the card production file, ready for delivery to customers.

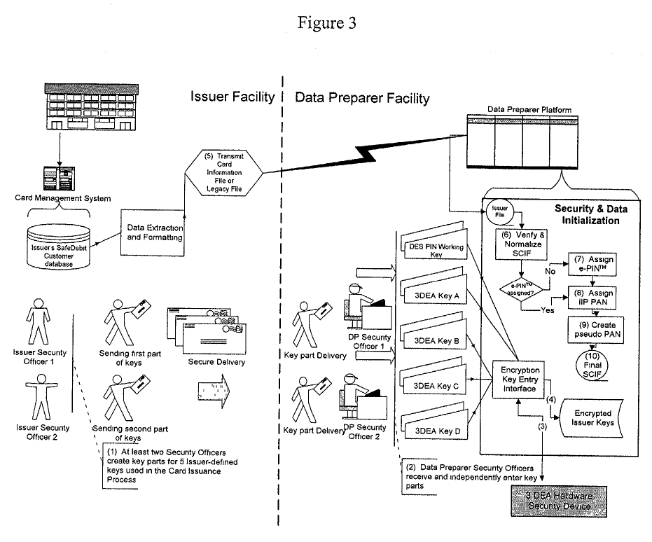

Further, FIG. 3 provides a detailed description of how the CIP functions in an exemplary aspect of the present invention. The following steps describe the tasks required to initialize the Data Preparer's platform. When these steps are complete, the platform contains all the components necessary to create a Card Production File (CPF).

Step 301: Key Creation and Secure Delivery

The Issuer creates four 3DEA Keys of two or three parts each for use in encrypting authentication, demographics and Issuer card data for use in the present system. In one aspect of the present invention, Issuer keys are composed of at least two parts created independently by at least two independent security officers. The key parts can be delivered independently by a secure means to at least two security officers employed by the Data Preparer.

The Issuer also sends a fifth key; for example, either a PIN calculation/validation key (PVK), or a PIN encrypting key (PEK). This Key enables the Data Preparer to calculate either Issuer PINs and triple DES encrypt them for writing to the e-commerce card, or to receive encrypted PIN blocks (under the working key) and translate them into a triple DES encrypted value. This key may be created and delivered by other acceptable means.

Step 302: Secure Key Receipt and Entry

The Data Preparer security officers receive and enter all key parts for the four 3DEA encryption keys. Preferably, security officers should not simultaneously enter more than one part of the same key at terminals in proximity to each other. At all times, care should be taken by the Data Preparer to ensure no more than one part of any given key is known in the clear to any single security officer.

The Data Preparer security officers receiving the Issuer PIN key parts should enter them independently. PIN keys may be sent to the same DP security officers as those that receive the 3DEA keys, or they may be sent to different security officers.

Step 303: Key Cryptograms

Key parts are sent to the hardware security device. Key parts should only be combined in internal processing of the hardware security device. The hardware security device returns an encrypted value (a cryptogram) for each complete key. Keys are encrypted under the Master File Key (MFK) of the device.

Step 304: Storing Key Cryptograms

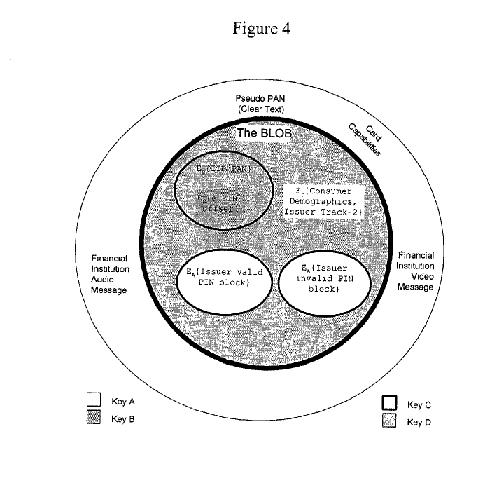

The key cryptogams are passed between the hardware security device and the platform using a switch working key. They are stored for use in encrypting the BLOB as depicted in FIG. 4.

Step 305: Issuer Creates Cardholder Information or Legacy System File

Issuers may select e-commerce cardholders from their customer base and can extract the consumer/business data already available on their card management systems. They may also collect consumer/business cardholder information through an application process.

The Issuer may choose to provide a legacy format file directly already available from their card management system, as long as it contains all of the required data.

Step 306: Verifying and Normalizing Issuer File

The Cardholder Information File (CIF) is received by the Data Preparer Module and verified to ensure data transmission errors did not corrupt any of the data. If the issuing Financial Institution chose to submit a legacy format file, the Data Preparer will normalize the Issuer file into a defined standard CIF layout.

Step 307: Assigning E-Pin

If an e-PIN value was not assigned to each card record by the Issuer, the Data Preparer will randomly assign an alphanumeric e-PIN value to each record. The e-PIN value will be generated by a secure module and returned as an encrypted value for secure storage in the CIF record.

Step 308: Assigning IIP Pan

Using software routines, the Data Preparer randomly assigns an IIP PAN value to each record. In one aspect of the present invention, a 64-bit, randomly generated value is used. The IIP PAN should be encrypted under a unique Data Preparer working key.

Step 309: Assigning Pseudo Pan

The Data Preparer creates a Pseudo PAN for each e-commerce card record of the present invention. This should be done in a manner consistent with the issuer definition of the cardbase issued using that prefix/BIN.

Step 310: Writing the Final CIF Record

The Data Preparer defines the system flags based on the presence or absence of multiple account data in the transmission.

The Data Preparer appends the additional data defined in steps 307-309 to each data record and writes a complete CIF record to the final Cardholder Information File.

After security and data initialization, token initialization and production file creation occur, as shown in FIG. 3.

Next, the e-commerce card contents are shown in FIG. 4. This figure provides a conceptual schematic of the card contents and its encrypted layers. The actual physical layout of the card may differ to allow for a secure means of reading the CD-ROM without giving away the exact location of the secure consumer information. Information for each transaction is read from the card in a unique manner as defined by a specific Pick List selected for use in a particular transaction conducted in the present system. The scheme employed for card reading and building the BLOB message component prevents the BLOB from being usable without employing the necessary algorithmic steps to unscramble and re-sequence its pieces.

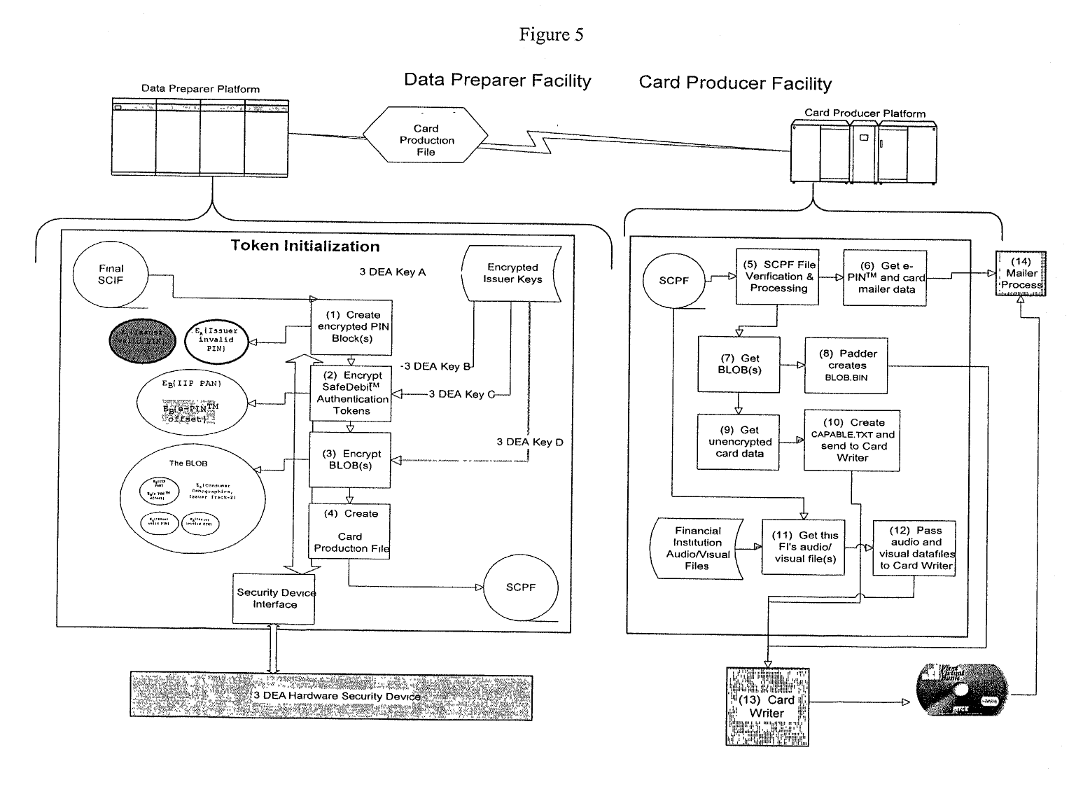

Referring now to FIG. 5, which is an exemplary description of the development of card data for the present invention as developed during the Card Issuance Process. The CIP, in one aspect, includes securing the cardholder data and payment tokens using four sets of double length 3DEA Keys. The supplied Legacy PIN Block is translated from DEA to 3DEA using a set of double length Keys (Key A). The supplied Invalid Legacy PIN Block is similarly translated to 3DEA using the same set of double length Keys (Key A) used to encrypt the valid PIN Block. The IIP PAN (supplied or fabricated), along with the e-PIN, is sent to the HSM with two new sets of double-length 3DEA Keys (Keys B & C). 3DEA Key B is used to fabricate an e-PIN offset. The 3DEA Key C is used to encrypt the IIP PAN and newly fabricated e-PIN offset to render them unintelligible outside an HSM validation process. The 3DEA encrypted Valid and Invalid Legacy PIN Blocks are grouped with the e-PIN validation Block. Together they are combined with the consumer demographics and Legacy Track-2 data to be encrypted under a final unique 3DEA Key (Key D). Finally, the unencrypted data required for AWC processing and transaction routing are provided in the form of independent data files. This data may include visual and audio elements, as well as the Pseudo-Track-2 data. The resulting data for each cardholder is passed to the Card Producer for further obfuscation via the Data Padder and subsequent placement on a card.

Referring again to FIG. 5, a functional flow diagram is described below. The following steps occur at the Data Preparer after platform initialization is complete. They result in the creation of the system Card Production File (CPF).

Step 501: Create Encrypted Pin Blocks

The Data Preparer Module creates 3DEA encrypted PIN blocks using the PIN data provided by the Issuer. The Data Preparer Module will either calculate Issuer valid and invalid PINs, or translate PIN blocks for each provided by the Issuer. Either way, the resultant PIN blocks are encrypted under 3DEA Key A.

If the issuer does not provide the necessary PIN data in their CIF or legacy system file, the Data Preparer Module will calculate PIN and offset values using issuer-provided keys, decimalization tables and PIN block formats. To calculate an invalid Issuer PIN, the Data Preparer Module will modify significant digit(s) in the issuer PAN before sending the PIN calculation request to the Hardware Security Device.

Step 502: Authentication Tokens

The e-PIN offset is calculated using issuer 3DEA Key B. The IIP PAN is translated from the Data Preparer Module working key to an encrypted value and combined with the e-PIN Offset. Collectively, they are encrypted under 3DEA Key C and are referred to as the e-PIN Validation Block.

Step 503: Blob Creation

The cardholder demographics and Issuer Track-2 data are read from the final CIF, combined with the 3DEA encrypted e-PIN Validation Block, valid Issuer PIN block and invalid Issuer PIN Block. Collectively, they are encrypted under 3DEA Key D. The result is referred to as the BLOB, and contains the complete required secure cardholder information. One BLOB is created for each set of access account types provided so that one card may be encoded with more than one BLOB. For example, one card could be encoded with both debit and credit information for executing either type of transaction. Further, a single card may support other types of transactions as understood by one of ordinary skill in the art.

The Data Preparer Module formats each BLOB field in a precise and known manner. For fields that are longer than the real data, or that do not contain real data, the Data Preparer Module can mark the point at which real data ends and pads with random characters beyond that point.

Step 504: Write Card Production File Records

Additional clear text data is read from the final CIF including the Pseudo PAN, card capabilities data, and the cardholder name and mailing address information. Along with the e-PIN value and encrypted BLOB, this data is written to a Card Production File record for each cardholder.

Step 505: Card Production File to Card Producer

The CPF is transmitted to the Card Producer and verified to ensure no data corruption occurred in transmission. During verification processing, the Card Producer assigns a batch output ID that will be associated with each output file related to this cardholder. The e-PIN mailer and card carrier, BLOB.BIN and CAPABLE.TXT files will all be assigned the same batch output ID. The Card Producer uses the ID to ensure that the expected data is written to the card and the e-PIN mailer is sent to the correct person.

The BLOB.BIN is an obfuscated data file containing the BLOB data. The CAPABLE.TXT is a data file containing clear text.

In one aspect of the present invention, a BLOB will be created in accordance with the following layout. The contents of a BLOB in its decrypted (plain-text) state is described below. A BLOB will be in this state at two junctures during its lifecycle. First, as an input to the final encryption call made to a Hardware Security Device during Card Issuance Data Preparer processing. Second, during IIP transaction processing immediately following the first call to a Hardware Security Device, which decrypts the BLOB. The term BLOB, in the context of this discussion, refers to the information contained in the Data field of the command sent to the Hardware Security Device to complete final BLOB encryption, and as referred to in step 503 above.

In one aspect of the present invention, each BLOB is exactly 480 Bytes in length. The data is in binary form and ready to be processed by a Hardware Security Device. Generally, data in a BLOB is position sensitive. BLOBs do not have internal field delimiters. For fields that are not fully populated, a pad marker character can be placed after the “real” data and the balance of the field is filled with random alphanumeric pad characters. Each field is a fixed length, allowing for positional parsing after decryption.

A simple example of this follows representing two fictitious data elements: name and city. Assuming both fields to be 25 characters in length, the name to be David, the PAD marker to be an * and the city to be Boulder, the BLOB would consist of the following data:

David*RfE34cVaQ3LmnJtY3TyBoulder*eWhG60nkCFDeqa16v

This scheme will ensure that hackers cannot use statistical pattern matching to discern encryption keys. The format is the same for every BLOB read from a card with a given Card Version Number. Card Version Numbers are extracted from the card and supplied by the AWC to the MPM in a transaction request message.

The plain-text version of a BLOB is referred to as the Cardholder Token Set (CTS). In an exemplary aspect of the present invention, each position is one byte/eight bits in length. An example of a CTS for the e-commerce data layout is shown in FIG. and is further described below. In addition, one CPF will be created and transmitted for each CIF processed by the Data Preparer Module. CPF header records may be appended to the beginning of the detail records to prepare a file for transmission. Header records can be used to identify the source of the file, the Issuer and BIN to be processed, as well as other pertinent information about the file. As with the CIF trailer record, the CPF trailer record can be used by the Card Producer to verify it has received all file records the Data Preparer Module expected to send.

In addition, a sound file may optionally be created by the issuer and delivered to the Data Preparer Module. A single issuer cardbase can have the same sound file on all of its cards. The sound file will play after the user enters their e-PIN. Further, graphic image files that display when the e-commerce card has been spun up on the user's CD-ROM drive can be provided. The AWC Applet can select the correct file to display based upon the user's screen resolution.

The following steps 506 through 512 describe the reading of the Card Production File and manipulation of data to create multiple files to be written to the e-commerce card.

Step 506: Extract Mailer Data

A Card Producer routine extracts the mailer data required from CPF fields and send it to the Mailer Process. This includes the e-PIN value, as well as the name and address information. The batch output ID is assigned to relate the mailer data to the card produced, ensuring that the correct and corresponding cards and e-PINs are sent to the right people.

The mailer process prints envelopes and prepares card carriers for insertion of the card when complete. Additionally, the mailer process prints the e-PIN to a single sheet of paper that includes the cardholder name. The e-PIN mailer sheet contains standard text used in PIN mailers that identifies what is being sent, and cautions the cardholder to always keep the number secure. It may also contain Issuer customer service contact information. This sheet of paper should be immediately and automatically enclosed in an envelope with the cardholder's name and address on the front. Printing and preparing the e-PIN mailer for posting should be an entirely automated process requiring no human intervention that could compromise the security of the e-PIN values.

Step 507: Get Blob(s)

The BLOBs are read from the appropriate field of the CPF record and sent to the Data Padder module. Within the Data Padder module a Data Map and Key are used to randomly distribute BLOB data within a large file.

Step 508: Create BLOB.BIN

In an exemplary aspect of the present invention, the output of the Data Padder is delivered to the Card Writer in the form of a 16 MB file in a manner that obfuscates its contents. The manner in which this file is created minimizes the risk that it can be read or downloaded by a hacker that might gain access to CD ROM read capabilities during transaction processing. In this example, the file is given the name “BLOB.BIN,” although other names may be used.

Step 509: Get Un-Encrypted Data

Clear text data is read from the CPF record for use in creating the clear text file CAPABLE.TXT to be written to the card. As with BLOB.BIN, names other than CAPABLE.TXT may be used.

Step 510: Create CAPABLE.TXT

The clear text data file CAPABLE.TXT is created and sent to the Card Writer for encoding.

Step 511: Audio and Visual Files

If audio and visual files for this Issuer were transmitted from the Issuer to the Data Preparer earlier on in the Card Issuance Process, the Data Preparer transmitted the files to the Card Producer in preparation for the first cycle of card issuance for this Issuer.

Step 512: Audio and Visual Sent to Card Writer

If applicable, the audio and visual files are read and sent to the Card Writer for burning. The files are sent to the Card Writer exactly as received from the issuer. Manipulation and verification of these files is not required by the Data Preparer or the Card Producer.

Step 513: Burn E-Commerce Card

The files are burned onto the e-commerce card at the Card Writer. The end result after the burning performed in this step is a complete e-commerce card. The card may be accompanied by a sleeve, which may or may not have issuer-specific information printed on it.

Step 514: Send Cards to Mailer Process

As shown in this step, cards are sent to the mailer process and stuffed into the appropriate envelopes for mailing to the cardholder. The e-PIN mailers and card mailers are sent separately. Card mailer packages may include a sheet of paper with printed information about the card, issuer customer service information and what to do if the corresponding e-PIN has not arrived in the mail by a specific date.

The following sections detail the functions to be performed by the data padder, the input data and parameters required, as well as the outputs are described.

In an exemplary aspect of the present invention, the data padder uses a data map unique to each card version number as its guideline for laying down BLOB data within a 16 MB BLOB.BIN file. In this example, preferably, the data map should be approximately 20 MB in size. The data map detail record is preferably of the following structure. A variable number of records exist, which when used for processing results in multiple copies of BLOB data being written to various positions within BLOB.BIN. The data map file contains a header and trailer record to identify the beginning and end of the file, as well as the card version number to which the data map applies.

Other data padder inputs may include a 512-byte, alphanumeric key per BLOB and the BLOBs. The BLOBs are read from the Card Production File.

In one aspect of the present invention the creation of BLOB.BIN is a RAM-based process, which involves holding all data in RAM for each cardholder record processed until that card's BLOB.BIN file is complete.

In an exemplary aspect, preferably, for each cardholder record processed, the data padder initializes a 16,777,216 byte file with random characters. As each data map record is executed, the data padder writes to a portion of the initialized file.

When the data padder has completed its processing tasks, some percentage of BLOB.BIN will contain meaningful data, and the remainder will contain random “noise”. The random background noise is re-initialized for every cardholder record processed.

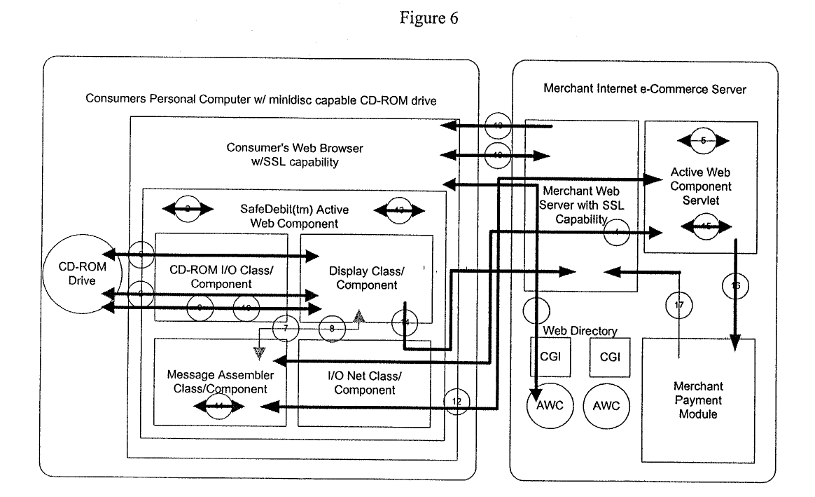

Turning now to FIG. 6, which depicts exemplary steps involved in generating an AWC transaction request message and receiving an AWC authorization response.

Step 601: Browser Request for SSL and AWC Applet

Request: The consumer selects debit as the method of payment. This causes the browser to request an SSL connection via an HTTPS or similar request for Active Web Component (AWC) Applet.

Process: The web server completes the handshake with the browser by returning its SSL certificate and public key, thereby establishing an SSL connection.

Response: The web server makes a CGI call. The CGI reads the HTTPS request header and returns the appropriate AWC Applet based upon the consumer's browser, over the SSL connection.

Step 602: Launch AWC Applet on the Consumer's PC

Process: The browser loads Java applet, ActiveX controls or the like, and launches the Active Web Component Applet.

Step 603: Access the E-Commerce Card

Process: The Display Class/Component creates a dialog box that prompts the consumer to insert his/her e-commerce card.

Process: The CD-ROM I/O Class/Component reads the CD-ROM drive and checks for the presence of an e-commerce card.

Process: Once the card is detected, the CD-ROM I/O Class/Component retrieves data regarding the file structures contained on the e-commerce card and places them in memory for transmission to the AWC Servlet in Step 604, for example: the names of each file on the e-commerce card; size in bytes of the file BLOB.BIN; card version number as extracted from the Card Capabilities File; and the total data size of the card in bytes.

Once this step is complete, two concurrent threads of execution begin in the Applet.

Step 604: Gather a “Pick List” from the AWC Servlet

Process: The Message Assembler Class/Component formats a request for a Pick List by gathering the card file structures garnered from the card in Step 603 and including a flag indicating a need for a debit Pick List (as opposed to a credit one).

Request: The request is forwarded by the I/O Net Class Component to the AWC Servlet in the form of a secure HTTPS, or similar, request.

Step 605: AWC Servlet Processing

Process: The AWC Servlet is launched by the merchant's web server to field the request. The Servlet reviews the contents of the “Pick List” request and determines if the card and requesting Applet are valid.

Process: The AWC Servlet selects a Registered Pick List (RPL) for the Applet.

Process: The AWC Servlet randomly expands the scope of each RPL element by increasing the size and starting position of the element, effectively capturing more data than what is required by each RPL element. The position and expansion of the RPL elements is retained in the queue discussed below. The expanded RPL is referred to as the Local Pick List (LPL).

Process: The AWC Servlet assigns a unique transaction ID for its interaction with the Applet. This transaction ID will be known only to the Applet and Servlet and is not intended to be part of the submitted transaction request as it is forwarded to other entities, such as an MPM, for processing.

Process: The AWC Servlet stages information about the “Pick List” request in a queue in anticipating a subsequent transaction request from the AWC Applet, for example: the unique transaction ID; the RPL number; the “Local Pick List” (LPL) expansion details as randomly generated above; and the disposition of the validation of the requesting AWC Applet and e-commerce card.

Process: The AWC Servlet formats a response for the Applet that includes the Local Pick List (LPL) and the unique transaction ID.

Response: The AWC Servlet returns the response to the Applet.

Step 606: Gather the Payment Data from the E-Commerce Card

Process: The CD-ROM I/O Class Component gathers the data as required by the Local Pick List from the e-commerce card and places it in memory.

Step 607: Select an Account

Process: The Display Class/Component interrogates the Card Capabilities plain text file contents that are garnered from the card. The Card Capabilities File Version Number Flag is reviewed to insure that the supplied card is system capable. If so, a list of the system accounts on the card is displayed for the consumer to choose from based on data in the Card Capabilities file.

If the system is not enabled for the inserted card, the applet will inform the consumer that the present inventive system and method are not a function of the inserted card. The execution thread for steps 604 and 605 will be terminated and the Applet will exit, returning the consumer to the merchant's check out screen from which debit was selected in the first place.

Process: The pseudo-PAN, read from the Card Capabilities plain text file, is forwarded to the Message Assembly Class/Component and stored in memory.

Process: The consumer selects the desired account from the list of plain text descriptions. The position of the selected account from the list, along with the associated Account Qualifier, are forwarded to the Message Assembly Class/Component and stored in memory.

Step 608: Collect the E-Pin

Process: Optionally, the Display Class/Component retrieves the bank-designed graphic file from the card, for presentation to the consumer. While displayed, the Display Class/Component creates a dialog box, prompting the consumer to enter his/her e-PIN.

Process: The Display Class/Component captures the e-PIN and forwards it to the Message Assembler Class/Component.

After the completion of Steps 606 and 608 indicating the completion of both of those execution threads, processing proceeds to Steps 609 and 611 where two new execution threads are launched.

step 609: Present Bank Audio/Transaction-In-Process Messages

Process: If applicable, the Display Class/Component interrogates its operating environment and retrieves the correct bank-designed Graphic Image File (based on the operating environment resolution) and the bank-designed audio file from the card and presents it to the consumer.

Process: Optionally, the Display Class/Component additionally displays the merchant branded transaction-in-process message (compiled in AWC), until the authorization response is returned from the network.

Step 610: Remove the E-Commerce Card

Process: The Display Class/Component creates a modal dialog box over the merchant branded transaction-in-process message that prompts the consumer to remove their e-commerce card from the CD-ROM drive. Optionally, the consumer will not be able to proceed with the transaction until the card has been removed.

Process: Once the consumer clicks “OK”, the CD-ROM I/O Class/Component polls the CD-ROM drive to ensure the card has been removed.

Step 611: Create the Transaction Request Message

Process: The Message Assembler Class/Component retrieves the appropriate message contents from memory and formulates a transaction request message for presentation to the AWC Servlet may include the following elements: the unique Transaction ID returned from the AWC Servlet in Step 605; the unique Applet ID Number (AID) that is compiled into the Applet during its construction; the pseudo-PAN data garnered from the e-commerce card in Step 607; the Account Qualifier data garnered from the e-commerce card in Step 607; the position of the desired account to be charged as collected in Step 607; and the e-PIN supplied by the consumer in Step 608.

Step 612: Submit the Transaction Request Message to the AWC Servlet

Request: The transaction request message is submitted to the AWC Servlet from the Message/Assembler Class/Component, via the I/O Net Class/Component, over the established SSL connection.

Response: AWC Servlet confirms receipt of transaction request. This causes the Message/Assembler to yield control to the Display Class thread. If the response is an invalid message response then the Applet terminates with an invalid action displayed to the consumer.

Assuming a successful response from the Servlet, there is one active thread on the Apple controlling activities and one active on the AWC Servlet to process the transaction request. No cardholder data should be available to the merchant at this step.

Step 613: Garbage Collection

Process: AWC Applet runs the garbage collector to delete all transaction data references, including the e-PIN, from memory.

Step 614: Submit a Request for Transaction Response

Launch Request Delay Timer: The AWC Applet may execute function to delay the run of the Request for Transaction Response, for example, a 5-second wait time. The purpose of this is to prevent the Applet Request from timing-out prior to receiving the response from the MPM.

Request: The Display Class/Component creates and submits a request for transaction response to the Merchants Web Server, via the Net I/O Class/Component (over the SSL connection).

Response: The transaction response is delivered to the consumer browser by the MPM. This response will displace the Applet in the browser display when it returns. The displaced Applet will terminate itself when the response is presented.

Step 615: AWC Servlet Processes Received Transaction Request

Process: The AWC Servlet receives the inbound response from the Applet and matches it against queued Pick List requests by comparing the supplied unique Transaction ID to outstanding requests. If a match is found, a confirmation of receipt is returned to the Applet as noted in Step 612 and message formulation continues. If not, the transaction is terminated and an invalid message request response is returned to the Applet, rather than a message received response.

Pick List requests that have been queued on the server by the Servlet will be expired and deleted if they are not matched with an incoming request from an Applet in one minute.

Process: The Servlet validates the Applet Identification Number (AID) received from the Applet. If it is valid, no further action is taken as a result. If it is not valid, the transaction is flagged as a suspect for an unknown AID Number. In either case, processing continues.

Process: The AWC Servlet gathers a transaction timestamp, for example, GMT, for the transaction request from the server environment. This timestamp is used to represent the Transaction Date and Time as well for scrambling the BLOB and e-PIN. In one aspect, the form of the timestamp is YYMMDDHHMMSS.

Process: The AWC Servlet appends the pseudo-PAN garnered from the consumer e-commerce card with pseudo discretionary data composed of the transaction time and the Registered Pick List Number, to fabricate pseudo Track-2 data.

Process: The AWC Servlet uses the Pick List expansion details as queued in Step 605 to remove the extraneous data collected with the Local Pick List (LPL), returning the data collected to what the Registered Pick List (RPL) required.

Process: The AWC Servlet uses a formula known to the Servlet and IIPs to scramble the BLOB based on the timestamp garnered above.

Process: The AWC Servlet uses a formula known to the Servlet and IIPs to scramble the e-PIN based on the timestamp garnered above.

Process: Prior to submitting the request to the MPM and as a final step in building the transaction request message for the MPM, the AWC Servlet converts the BLOB (Binary Large Object data) and then the e-PIN into Character Hexadecimal, CLOB (Character Large Object data) representation.

Process: The Servlet formats a transaction AWC request message to be supplied to the Merchant Payment Module (MPM) that may include the following: the pseudo Track-2 (included pseudo Track-2 and Pseudo Discretionary Data); the CLOB, now scrambled in time-sensitive fashion; the AWC Servlet License Number as registered with the IIP; the position of the desired account to be charged; the Account Qualifier as extracted from the Card Capabilities File; the e-PIN as supplied by the consumer, now scrambled in time-sensitive fashion; and the disposition of validity checking for the transaction (suspect or not).

Step 616: Servlet Submits Request to MPM

Process: The Servlet delivers the transaction request to the MPM. Upon an affirmative response of receipt of the request from MPM, AWC Servlet removes the unique transaction ID and other materials from its open request queue. The response handling that is returned to the consumer is handled via the MPM and the merchant web server. The Servlet thread terminates.

Step 617: MPM Returns the Response

Positive Response: If the transaction has been approved, MPM forwards the authorization message, cardholder name, and statement address to the merchant checkout stand on the web server.

Negative Response: If the timeout value defined on the merchant web server is exceeded before the response message arrives, or the transaction is denied for any other reason, MPM supplies the denial response to the merchant web server.

Step 618: Browser Displays the Response Message

Response: The merchant web server delivers the receipt/transaction response to the consumer browser. The contents of this transaction confirmation may provide the following: receipt number; textual representation of the transaction state (approved or denied and reason for denial); amount; location of transaction; and description of transaction.

AWC yields control to the browser and closes. The browser presents the response to the consumer.

Step 619: Complete the Purchase

Request: The consumer verifies or modifies the name and address information for shipping, and approves or cancels the transaction.

Response: The merchant web site presents the consumer with a final receipt.

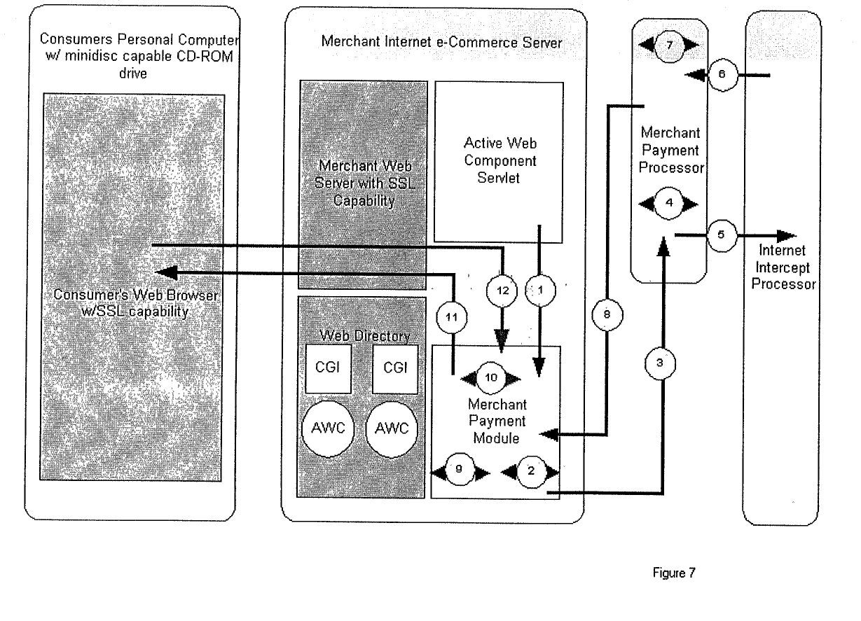

Turning next to the Merchant Payment Module. FIG. 7 depicts the steps involved in an MPM transaction request and response message. The formats of the messages described in the steps of FIG. 7 are consistent with the following:

(a) Steps 701-704: The message format used is at the discretion of merchant (MPM) and the merchant payment processor (MPP).

(b) Steps 705-707: The preferred message format used is the ISO 8583 Message Format.

(c) Steps 708-712: The message format used is at the discretion of merchant (MPM) and the merchant payment processor (MPP).

Step 701: AWC Servlet to Merchant Payment Module

The consumer selects debit as the method of payment. The AWC Servlet collects the necessary customer payment tokens and transaction information and forwards the message to the MPM.

Step 702: MPM Processing

MPM creates a transaction request message, which can be constructed in any format agreeable to both the merchant and the Merchant Payment Processor. If the MPM is connected directly to the IIP, preferably a ISO 8583 message should be used.

Step 703: MPM to Merchant Payment Processor

MPM assigns the unique Trace Number and Retrieval Reference Number to the payment token data and launches the authorization timer. MPM initiates secure transmission of the transaction request message to the Merchant Payment Processor. This message format is at the discretion of the MPM and MPP.

Step 704: Merchant Payment Processor

Merchant Payment Processor reads the BIN number from Track-2 in the transaction request to determine the routing destination. The Merchant Payment Processor reformats this transaction request into a System ISO 8583 message.

Step 705: MPP to Internet Intercept Processor

Merchant Payment Processor initiates secure transmission of the System ISO 8583 transaction request message to the IIP.

Step 706: IIP to Merchant Payment Processor (Return)

The IIP initiates transmission of the System ISO 8583 authorization response message, in the same secure manner as the request, to the Merchant Payment Processor.

Step 707: Merchant Payment Processor (Return)

Merchant Payment Processor matches the response message to the original transaction request.

Step 708: Merchant Payment Processor to MPM (Return)

Merchant Payment Processor returns the authorization response to the correct merchant MPM. Again, this message format is at the discretion of the MPM and MPP. In the event the response is an approval this message may include the cardholder name and statement address, as supplied by the IIP. If the response is a denial, this information preferably should not be supplied by the IIP.

Step 709: Merchant Payment Module (Return)

The Merchant Payment Module parses the authorization response from the MPP and prepares a response to consumer. The response data may include the authorization code, transaction “receipt” data, cardholder name, and statement address.

Step 710: Merchant Payment Module Timer (Return)

The Merchant Payment Module may also launch an active timer, for example, four-minutes in duration, to stage the transaction response back from the consumer browser. In the event a response is not received from the consumer browser, the MPM initiates a reversal message back to the MPP. Or, if a response is received late from the consumer browser (four minute timer expired), the MPM initiates a reversal message back to the MPP and also initiates a message back to the consumer browser indicating that that the transaction timed-out.

Step 711: MPM To PC Via Merchant Web Server Interaction (Return)

The MPM provides the order summary to the consumer for verification, which may include: Confirmation/Order Number; Retrieval Reference Number (if different from Confirmation/Order Number); last four digits of the Pseudo PAN as found in Track-2; cardholder name; statement address, displayed as shipping address; items (description and quantity) to be shipped; shipping dollar amount; total dollar amount; and option to verify or modify the shipping information or cancel the transaction.

This data is returned to the cardholder browser in response to the open authorization request originally launched by the AWC.

Step 712: PC to MPM Via Merchant Web Server Interaction (Return)

The consumer verifies or modifies the shipping information, and approves or cancels the transaction. The MPM interrogates the response back from the cardholder browser and: considers the transaction complete with a cardholder positive verification; updates shipping address and considers transaction complete with a cardholder modification of the shipping address; and initiates a reversal to the MPP and considers transaction incomplete with a cardholder cancellation. The Merchant Web Server presents the consumer with a final receipt as to the status of the transaction. Turning next to the Internet Intercept Processor capabilities. The IIP can manage all administrative functions associated with linking to an EFT Network Switch, including application handshakes, processor sign on and sign off, dynamic key exchange, end-of-day cutoff, and denial of merchant messages that have an invalid format. These functions can be accomplished using the EFT Network's Network Management messages.

The IIP can optionally manage administrative functions with a Merchant Payment Processor. These functions may include exchange of application handshakes, processor sign on and sign off, end-of-day cutoff, and denial of merchant messages that have an invalid format. Dynamic key change management is not required with the MPP. These functions may be accomplished using the existing Network Management Messages.

The IIP complies with the transmission security requirements of each EFT Network that participates in the System. In addition, the IIP manages the exchange of transactions with web merchants or other third party entities (e.g. Merchant Payment Processors) using, for example, one of the following transmission security configurations, such as SSL over a public network or use of a dedicated circuit.

IIP can maintain a tamper resistant security module (e.g. Atalla platform, or other certified device), capable of DEA and 3DEA encryption and translation functions that is additionally enabled with the proprietary System cryptographic calls In addition, the IIP maintains an on-line transaction processing (OLTP) database, with data sufficient to process the data extraction formulae and associate the correct keys to a given message; complies with EFT Network connectivity requirements; can be certified by the EFT Network as a Direct Processor; and can populate and manage the Issuer keys in accordance with ANSI key management standards and the concepts of split knowledge and dual access controls.

The EFT Network Switch can initiate dynamic key exchange with the IIP periodically according to Network Rules. The IIP can respond to the EFT Network Switch messages used to exchange new PIN Encrypting Keys (PEKs) (a.k.a. “working keys”) and accurately load the new key. New PEKs can be generated and transmitted by the Network Switch security routines and encrypted under the Key Encrypting Key (KEK) established at link implementation.

IIP security modules can populate and manage Issuer 3DEA keys in accordance with ANSI key management standards and the concepts of split knowledge and dual access controls. The IIP can support the following transaction types: purchase, delayed purchase, payment, recurring payment, merchandise return (credit), delayed merchandise return and consumer information verification.

The IIP can validate a request by verifying timeliness, by confirming that the AWC license number submitted is valid, and by authenticating the consumer through e-PIN verification. The pseudo Track-2 information can be used to determine the destination and identify the appropriate keys for decrypting the true cardholder data held in the CLOB.

In another aspect of the present invention, the IIP is capable of determining whether or not the issuer is enabled to process the native System ISO 8583 messages. This can be accomplished by using an Issuer IIP database parameter. If the issuer is enabled, the IIP forwards the native System ISO 8583 request message to the issuer via their EFT Network without performing any parsing functions. If the issuer is not enabled, the IIP can perform parsing, decryption, PIN translation and message re-assembly on behalf of the issuer, effectively converting the System ISO 8583 messages into issuer native legacy messages. This functionality would only be “on” when Issuers and EFT Networks support native e-commerce card transactions of the present invention and Issuers operate IIP modules at their sites.

IIP acquirer routines can log all transaction data that may be required for settlement and/or exception processing to a unique log or audit file. Each transaction can be processed by the IIP and introduced to the next processor, within one second of transaction receipt by the IIP.

The following provides a description of exemplary IIP functions executed during a transaction in the present invention.

Active Web Component license numbers can be compared to valid values in an IIP database file. If the AWC license number sent by the MPM/MPP does not match any database file value, the request is denied for “invalid merchant or terminal.”

Upon receipt of a transaction request from a Merchant Payment Processor, IIP acquirer routines can check the unique timestamp in a special location in the System ISO 8583 message. A configurable issuer parameter defines a “timeliness window” in minutes. If the request is in the defined window, request processing continues. If received outside the window, the transaction request is denied for “invalid time.” The timestamp can be sent and processed as Greenwich Mean Time (GMT). This function can be bypassed for Merchant store-and-forward and resubmission transactions.

The AWC license number value can key into a file of Active Web Component object code locations. IIP acquirer routines can select the object code corresponding to the AWC license number in each inbound request. AWC object routines execute steps that extract the e-PIN value entered by the cardholder and holds it in memory. These routines can also unscramble the time-scrambled CLOB and e-PIN, using System specific data supplied in the System ISO 8583 message, and scrambling tables stored for each AWC license number. AWC object routines can return the e-PIN and CLOB in discrete, internal fields.

The AWC can build and send the CLOB as one block of scrambled, multiple, out-of-sequence pieces as determined by a “pick list” selected after the initial card read and by a BLOB Scrambling Table. IIP Acquirer routines can use specific data supplied in the System ISO 8583 message to look up rules for the re-sequencing of CLOB data. After processing according to the pick list rules, the IIP now has a sequential, unscrambled CLOB—which remains encrypted—and the clear e-PIN.

The CLOB can be passed with the e-PIN entered value and transaction time to the security routines. Using the Pseudo Track-2 routing information, security routines determine the Issuer and outbound processor (i.e., EFT Network) destination. The stored e-commerce card issuer cryptograms (Keys A, B, C and D) can be obtained from an IIP Issuer database file, along with the Network's current PIN Encrypting Key (PEK), also known as the “working key”. Using single or multiple e-commerce calls to the Hardware 3DEA Device, the security routines pass the e-PIN, CLOB and issuer key cryptograms to the device for cardholder authentication. This authentication is accomplished by verification that the entered e-PIN value is the same one that was assigned to the card when it was issued. Regardless of the verification result, the hardware device can return clear, decoded, Issuer Track-2 data from the CLOB.

If the e-PIN is valid, the hardware device translates the Issuer's valid PIN block and returns the Issuer PIN encrypted under the current Network PIN Encrypting Key using the Network PIN block format. If the e-PIN is not valid, the hardware device returns a result code indicating e-PIN verification failure. The IIP uses the invalid PIN block to build the PIN Data field in the outbound request.

The IIP can decrypt the CLOB, in hardware, using the same unique issuer keys that were used to encrypt the BLOB during card issuance.

Transaction messages can be translated and mapped to standard EFT Network messages. These transactions will be sent to the EFT Network in the standard POS message formats used in the physical world. Any of these transactions that are not standard EFT Network transactions can be mapped into the closest standard EFT Network transaction type available.

The Issuer Track-2 and PIN block are placed in the outbound request sent to the EFT Network. Pseudo cardholder information can be logged for future inquiry on exception transactions. When e-PINs are not valid, the PIN block placed in the message would be the invalid PIN block (as translated from 3DEA to the Network DEA key). Passing “invalid PIN” requests to issuers in this manner allows them to keep track of invalid PIN tries at the card level. IIP Issuer routines can send these now standard-format EFT Network transactions to the Network Switch. It can validate the request, translate the PIN block and forward the request to the appropriate Issuer.

These messages include data elements that are not required in current EFT Network transactions; e.g., the CLOB, timestamp, consumer address. In one aspect of the present invention, the Network may not be capable of processing the new e-commerce card elements. The IIP accommodates this by exchanging messages in Network format; therefore, the Network and its participating issuers need not modify their systems.

In another aspect of the present invention, the IIP performs its decryption, re-encryption and message mapping functions prior to submission to the EFT Network. In yet another aspect of the present invention, for an EFT Network that is capable of processing Transaction messages as native transactions, the IIP function may reside at the issuing Financial Institution. When this occurs, the EFT Network-operated IIP selectively defers transaction processing to the Issuer and is capable of passing through all of the transaction data elements.

An IIP clocks outbound requests that are pending authorization and time them out after a period consistent with EFT Network response time requirements. The timeout value should be large enough to allow Network issuer stand-in to occur and for that response to reach the IIP. As an alternative aspect, a timeout by the IIP results in a denial being returned to the Merchant Payment Processor, wherein the IIP would not stand in and authorize on behalf of an Issuer.

The IIP translates all Network responses into transaction responses and add transaction-unique fields to messages before they are sent to Merchant Payment Processors. Pseudo cardholder data is returned to the Track-2 field. The cardholder's decoded address, as returned by the Hardware 3DEA device and held in memory, is added to the System ISO 8583 response message in a private use field.

Finally, in one aspect of the present invention, the IIP triggers the sending of an e-mail to the consumer's e-mail address as received in the CLOB. The e-mail may contain text describing the transaction from the following data elements: Local Date and Time, Transaction Amount, Processing Code translated into text descriptions and the Card Acceptor Location merchant domain name. The e-mail may also contain standard text describing it as a message that should not be replied to. The reply address on the e-mail should be one that causes any reply e-mails that are sent to go to the Issuer.

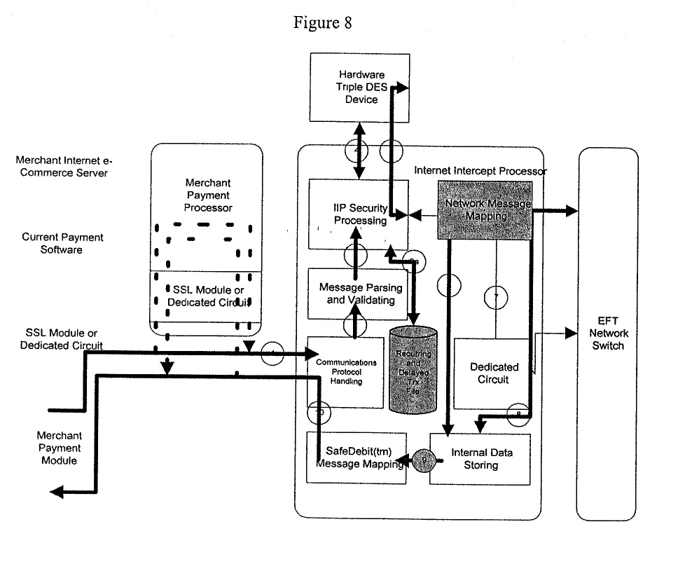

FIG. 8 depicts the detailed steps involved in the IIP processing an exemplary transaction request message and receiving a response message.

Step 801: Communications Protocol Handling

Upon receipt of the transaction request message from the Merchant Payment Processor/MPM, the IIP transport layer decrypts the message (as needed), and forwards it to the Message Parsing and Validating function. If a dedicated circuit is used for message transmission, communications protocol headers are stripped and no decryption is necessary.

Step 802: Parsing and Validating the Transaction Request

The Parsing and Validating function processes the transaction request message and places data elements in their correct internal field positions. The integrity of the request message is confirmed. These integrity edits are designed to detect message tampering and/or merchant replay.

The request is checked for timeliness, according to the Timeliness Tolerance issuer parameter. The timestamp is extracted from the incoming System ISO message and compared to the GMT value of the current IIP platform. The Pick List Number is also extracted from the incoming System ISO message and saved for later use during Security Processing.

The clear message text is inspected for proper formatting and content. Message data elements are inspected for key data elements that indicate the processing requirements of a transaction, e.g. message type identifier, recurring payments indicator, elements that indicate delayed purchase or merchandise return is being requested, age verification data, or merchant store-and-forward indicators. These key data elements will also trigger branching to a specific logic path in IIP transaction processing.

The AWC license number value is examined for authenticity of the requesting merchant web site by comparison to the IIP database file of valid merchant AWC license numbers. The AWC BLOB scrambling table is read from this file and saved for later use. The e-PIN scrambling table is also read from this file and saved for later use in Security Processing.

Should the request message fail any data element edit checking, the request will be rejected and returned to the Merchant Payment Processor/MPM with a denial response.

Step 803: Security Handoff

Having passed all message integrity edits, the message and data required for security processing is forwarded to the IIP Security Processing function. Security Processing performs important unscrambling and CLOB re-sequencing functions and manages input to and output from the Hardware 3DEA Device.

Step 804: Security Processing

Security processing steps are broken down below. The initial steps prepare the secure data for use in Hardware 3DEA Device commands. The CLOB is unscrambled and re-sequenced. The e-PIN is also unscrambled. The final steps send commands to the Hardware 3DEA Device to decrypt the BLOB, verify the e-PIN, examine the result and translate the appropriate Issuer PIN block to send on to the Issuer EFT Network.

The IIP parses other contents of the System ISO 8583 message and places the card version number, scrambled e-PIN data and CLOB into discrete internal storage locations.

Step 804A: Unscrambling the CLOB

Prior to unscrambling, the IIP converts the CLOB to its binary form, the BLOB. Using the transaction timestamp and the BLOB scrambling table, pulled from the merchant parameters file for this AWC, the IIP unscrambles the BLOB.

Step 804B: Reverse Pick List Operation—Re-Sequencing

Using the Card Version Number and Pick List Number, the IIP looks up the applicable pick list record from the Pick List file defined for that Card Version. It then re-sequences the components of the BLOB data element using the pick list obtained by database look-up using the inbound message's card version number and pick list number. The Pick List record is read as a variable length record, with the end of the record indicated by a blank character (space).

Elements of a pick list consist of alternating position and length information that indicates where to start reading from the BLOB and how much data to read. The data is written into sequential positions in an internal BLOB field allocated for the result. The reads are repeated for as long as the pick list contains elements. When a blank character is encountered in the pick list record, the reverse pick list operation stops and the content of the BLOB result is checked for length integrity against the input value.

Step 804C: E-Pin Unscrambling and Verification

Finally, the e-PIN is unscrambled using the e-PIN scrambling key passed from the parsing routines as read from the merchant parameters record for this AWC.

Step 804D: Calls to the Hardware DES³ Device

The first call to the hardware 3DEA device decrypts the first layer of encryption on the BLOB. Parameters to be passed to the device include the encrypted BLOB and Issuer 3DEA Key D. The device returns Issuer Track-2 and consumer demographics information in clear text and three encrypted blocks of data (authentication tokens, a valid Issuer PIN block, and an invalid Issuer PIN block).

The second call to the hardware 3DEA device sends the e-PIN, the e-PIN validation Block, the 3DEA Issuer Key (Key C), and the e-PIN verification key (Issuer Key B) to the Hardware 3DEA Device for e-PIN verification. It returns a result, which can be interrogated to determine which Issuer PIN block to use in the next step. If e-PIN verification is successful, the valid Issuer PIN block is to be used. If unsuccessful, the invalid PIN is used.

Step 805: Issuer Pin Translation

The appropriate 3DEA Issuer PIN block (from the decrypted BLOB) is submitted to the Hardware 3DEA Device for translation to a DEA PIN block, using Key A and the current PIN Encrypting Key (PEK) in place with the EFT Network. The single DEA PIN block is returned for use in EFT Network message mapping.

Now armed with all the necessary data elements, EFT Network message mapping builds the EFT Network request message.

Step 806: Storage of the Decrypted Request Message

A copy of both the original transaction request data and the decrypted request data is sent from EFT Network message mapping, for internal storage and re-use once the authorization response is returned from the EFT Network.

Step 807: Transmission of the Network Request

The EFT Network request message request is transmitted via a dedicated circuit to the EFT Network Switch.

Step 808: Receipt of the Network Response Message

When the EFT Network returns the response message, it is forwarded to the EFT Network message mapping and Internal Data Storing functions.

Step 809: Selection of the Response Data Elements

The system message mapping selects the elements it needs to create a System ISO 8583 system response message. Internal Data Storing passes these elements as saved from the original transaction request (prior to decryption), and from the decrypted CLOB. Elements from the Network response message are also used. The selected elements are all passed to the system message mapping function.

Step 810: Assembly and Transmission of the Authorization Response Message

Upon receipt of the response data elements, the system message mapping assembles the data elements into a System ISO 8583 response message.

The response is transmitted to the appropriate Merchant Payment Processor/MPM. The message can be SSL-encrypted if a public network is used for transmission.

An e-mail is sent to the consumer describing the transaction.

Additional features, which may also be provided in the present invention include, but are not limited to e-mail notification of card use, delayed or recurring purchases, delayed merchandise returns, registrations support, age verification, and Financial Institution branding with each purchase via visual- and audio elements.

As will be understood by one of ordinary skill in the art that while the embodiments described herein present the present invention as being accessed over the Internet using the World Wide Web, access could also be provided by software executing on a customer's personal or laptop computer, wireless telephone, PDA, memory stick, smart card or other public access network devices.

While the invention has been particularly shown and described with respect to a preferred embodiment thereof, it will be understood by those of ordinary skill in the art that the foregoing and other changes in form and details may be made therein without departing from the spirit and scope of the present invention.

What is claimed is:

1. A method of providing a payment service including the steps of:
processing a payment service request having independent identification information and a pair of ATM network compatible PINs, including the steps of:
validating said independent identification information; and
generating an ATM network transaction message containing at least a selected one of said pair of ATM network compatible PINs based at least in part on said validating step; and
forwarding said ATM network transaction message to a financial institution over an ATM network for payment.

2. The method of claim 1 further including the step of:
providing a data storage device for interacting with a network access device; said data storage device having said pair of ATM network compatible PINs stored thereon;
wherein each one of said pair of ATM network compatible PINs is independently encrypted and different from one another.

3. The method of claim 2 further including the step of:
generating said payment service request including said pair of ATM network compatible PINs and independent identification information.

4. The method of claim 3 further including the step of authorizing payment to a payee.

5. The method of claim 3 wherein said payment service request further includes an amount.

6. The method of claim 4 wherein said payment service request further includes an amount.

7. The method of claim 1 wherein said independent identification information comprises an electronic personal identification number.

8. The method of claim 1 wherein said validating step includes:
providing an independent identification information offset;
providing a transaction identifier representing an account number; wherein said transaction identifier does not represent said user's account number;
combining said user identification information and said offset to validate said user; and
associating said user identification information and said offset with said transaction identifier to validate a user.

9. The method of claim 7 wherein said validating step includes:
providing an independent identification information offset;
providing a transaction identifier representing an account number; wherein said transaction identifier does not represent said user's account number;
combining said user identification information and said offset to validate said user; and
associating said user identification information and said offset with said transaction identifier to validate a user.

10. The method of claim 9 wherein based at least in part on said validating step said ATM network transaction message includes a valid ATM network compatible PIN.

11. The method of claim 9 wherein said ATM network transaction message includes an invalid ATM network compatible PIN.

12. The method of claim 1 wherein said payment service request further includes a payee.

13. The method of claim 1 further including inputting said independent identification information at a network access device.

14. The method of claim 7 further including inputting said independent identification information at a network access device.

15. The method of claim 7 wherein said electronic personal identification number comprises a number other than a user's ATM network compatible PIN.

16. A data storage device having a data structure stored thereon, said data storage device for use by an application program, comprising:
said data structure characterized by:
a plurality of data fields stored thereon, at least some of said data fields containing segments of data; said data representing information relating to financial transactions;
wherein said data fields are arranged in a predetermined sequence so that said data representing information relating to financial transactions can be obtained by selecting one of two or more subsets of said data fields in a respective predetermined order.

17. The data storage device of claim 16 wherein said data representing information relating to financial transactions includes data representing identification and verification information.

18. The data storage device of claim 17 wherein said identification and verification information includes an ATM network compatible PIN.

19. The data storage device of claim 17 wherein said identification and verification information includes a pair of different ATM network compatible PINs.

20. The data storage device of claim 17 wherein said identification and verification information includes information relating to a particular bank account.

21. The data storage device of claim 20 wherein said information relating to a particular bank account includes an ATM network compatible PIN valid for said particular bank account and an ATM network compatible PIN not valid for said particular bank account.

22. The data storage device of claim 16 wherein said data storage device includes a plurality of data structures.

23. The data storage device of claim 22 wherein said plurality of data structures represent a corresponding plurality of bank accounts.

24. The data storage device of claim 17 wherein said identification and verification information includes track-2 data.

25. The data storage device of claim 24 wherein said track-2 data includes data representing a bank identification number.

26. The data storage device of claim 24 wherein said track-2 data includes data representing a primary account number.

27. The data storage device of claim 24 wherein said track-2 data includes data representing a primary account number.

28. The data storage device of claim 16 wherein said identification data includes customer demographic information.

29. The data storage device of claim 16 further including advertising data stored thereon.

30. The data storage device of claim 16 further including data representing a primary account number stored thereon; wherein said data representing a primary account number is one other than one used to identify a user's bank account; and wherein said data is used for tracking said financial transaction.

31. The data storage device of claim 16 wherein said data storage device comprises an optical disk.

32. The data storage device of claim 16 wherein said data storage device comprises a floppy disk.

33. The data storage device of claim 16 wherein said data storage device comprises a magnetic, optical or electrical storage medium.

34. A method of transferring data over a network from a user network access device connected to said network to a server connected to said network under control of said server comprising the steps of:
providing a data storage device having a data structure including data segments stored thereon, said data storage device for access by an application program;
operatively connecting said data storage device to said user network access device;
retrieving data from said data storage device; wherein said retrieving step includes the steps of:
randomly selecting a first of a set of predetermined sequences for retrieving at least some of said data segments;
randomly adding additional segments to be selected from said first of a set of predetermined sequences to form a new sequence;
gathering segments of data from said data storage device in accordance with said new sequence;
transmitting said segments of data to said server; and
sampling said transmitted data to reconstruct said segments of data in accordance with said first of a set of predetermined sequences.

35. The method of claim 34 wherein said data storage device comprises:
said data structure used by said application program and characterized in that:
a plurality of data fields are stored thereon, at least some of said data fields containing said data segments; said data representing information relating to financial transactions;
wherein said data fields are arranged in a predetermined sequence so that said data representing information relating to financial transactions can be obtained by selecting one of two or more subsets of said data fields in a respective predetermined order.

36. The method of claim 34 wherein said transmitting step further includes transmitting with said segments an identifier associated with said transmission.

37. The method of claim 36 wherein said identifier includes a plurality of identifiers.

38. The method of claim 36 further including validating said transmission based at least in part on said identifier.

39. The method of claim 37 further including validating said transmission based at least in part on said identifier.

40. A system for providing a payment service including:
a processor for processing a payment service request having independent identification information and a pair of ATM network compatible PINs, said processor configured to:
validate said independent identification information;
generate an ATM network transaction message containing at least a selected one of said pair of ATM network compatible PINs based at least in part on said validation; and
forward said ATM network transaction message to a financial institution over an ATM network for payment.

41. The system of claim 40 further including:
a data storage device for interacting with a network access device; said data storage device having said pair of ATM network compatible PINs stored thereon; wherein each one of said pair of ATM network compatible PINs is independently encrypted and different from one another.

42. The system of claim 41 wherein said processor is further configured to generate said payment service request including said pair of ATM network compatible PINs and independent identification information.

43. The system of claim 42 wherein said financial institution authorizes payment to a payee.

44. The system of claim 43 wherein said payment service request further includes an amount.

45. The system of claim 44 wherein said payment service request further includes an amount.

46. The system of claim 40 wherein said independent identification information comprises an electronic personal identification number.

47. The system of claim 40 wherein said processor is further configured to validate said independent identification information by:
providing an independent identification information offset;
providing a transaction identifier representing an account number; wherein said transaction identifier does not represent said user's account number;
combining said user identification information and said offset to validate said user; and
associating said user identification information and said offset with said transaction identifier to validate a user.

48. The system of claim 46 wherein said processor is further configured to validate said independent identification information by:
providing an independent identification information offset;
providing a transaction identifier representing an account number; wherein said transaction identifier does not represent said user's account number;
combining said user identification information and said offset to validate said user; and
associating said user identification information and said offset with said transaction identifier to validate a user.

49. The system of claim 48 wherein based at least in part on said processor validation said ATM network transaction message includes a valid ATM network compatible PIN.

50. The system of claim 48 wherein based at least in part on said processor validation said ATM network transaction message includes an invalid ATM network compatible PIN.

51. The system of claim 40 wherein said payment service request further includes a payee.

52. The system of claim 40 further including an input device for inputting said independent identification information at a network access device.

53. The system of claim 46 further including an input device for inputting said independent identification information at a network access device.

54. The system of claim 46 wherein said electronic personal identification number comprises a number other than a user's ATM network compatible PIN.

55. A system for transferring data over a network from a user network access device connected to said network to a server connected to said network under control of said server comprising:
a data storage device having a data structure including data segments stored thereon, said data storage device for access by an application program;
said data storage device operatively connected to said user network access device;
said server having said application program stored thereon; wherein said application program retrieves data from said data storage device; wherein said application program
randomly selects a first of a set of predetermined sequences to retrieve at least some of said data segments;
randomly adds additional segments to be selected from said first of a set of predetermined sequences to form a new sequence;
gathers segments of data from said data storage device in accordance with said new sequence; and
transmits said segments of data to said server; and
said server samples said transmitted data to reconstruct said segments of data in accordance with said first of a set of predetermined sequences.

56. The system of claim 55 wherein said data storage device comprises:
said data structure used by said application program and characterized by:
a plurality of data fields stored thereon, at least some of said data fields containing said data segments; said data representing information relating to financial transactions;
wherein said data fields are arranged in a predetermined sequence so that said data representing information relating to financial transactions can be obtained by selecting one of two or more subsets of said data fields in a respective predetermined order.

57. The system of claim 55 wherein said application program further transmits with said segments an identifier associated with said transmission.

58. The system of claim 56 wherein said identifier includes a plurality of identifiers.

59. The system of claim 56 wherein said server is further configured to validate said transmission based at least in part on said identifier.

60. The system of claim 57 said server is further configured to validate said transmission based at least in part on said identifier.

61. A method of a providing payment service comprising the steps of:
providing an encoded data storage device to a user; said encoded data storage device including:
data representing a first ATM network compatible PIN; wherein said first ATM PIN is a valid ATM PIN associated with said user's account at a financial institution;
data representing a second ATM network compatible PIN; wherein said second ATM PIN is an invalid ATM PIN not associated with said user's account at said financial institution;
providing independent identification information associated with said user's account at said financial institution;
validating said independent identification information;
generating a payment service request including a selected one of said first ATM PIN or said second ATM PIN based upon said validating step; and
forwarding said payment service request to said user's financial institution over an ATM network for further processing.

62. The method of claim 61 wherein encoded data storage device further includes a primary account number associated with said user's bank account stored thereon.

63. The method of claim 61 wherein said encoded data storage device further includes a bank identification number stored thereon.

64. The method of claim 61 wherein said generated payment service request is stored by a merchant for forwarding to a financial institution at a selected time.

65. The method of claim 61 wherein said forwarded payment service request is forwarded to said financial institution a plurality of times.

66. The method of claim 61 wherein said independent identification information comprises an electronic personal identification number.

67. The method of claim 61 wherein said payment service request further includes an amount.

68. The method of claim 61 wherein the step of forwarding said payment service request to said user's financial institution over an ATM network for further processing further includes authorizing payment to a payee.

69. The method of claim 61 wherein a merchant provides said independent identification information and data representing said first ATM network compatible PIN and said second ATM network compatible PIN received by a user to a processor for validating said independent identification information and generating said payment service request.

70. A method of providing a payment service comprising the following steps:
providing a data storage device to a user for interacting with a network access device connected to a network; said data storage device having a pair of encrypted ATM network compatible PINs and an primary account number (PAN) stored thereon generating a payment service request including said pair of encrypted ATM network compatible PINs, said PAN and an electronic personal identification number (e-PIN);
providing a processor;
receiving said payment service request at a location remote from said network access device;
generating a payment service message at said location remote from said network access device by adding an amount, and a payee to said pair of encrypted ATM network compatible PINs, said PAN and said e-PIN;
transmitting said payment service message over an ATM network switch to said processor;
processing said payment service message at said processor, including the steps of:
decrypting at least some of said encrypted information and determining if said e-PIN is proper to generate and communicate a message from said processor to said user's bank resulting in debiting of user's bank account electronically substantially in real-time including the step of generating a digital ATM network transaction message containing at least a selected one of said pair of ATM network compatible encrypted user PINs and said amount and applying said message to said ATM network; and
authorizing payment to said payee.

71. The method of claim 70 wherein said data storage device is encoded.

72. The method of claim 71 wherein said PAN is encoded.

73. The method of claim 72 including the step of providing a fabricated PAN for tracking said payment service message.

74. The method of claim 70 wherein said location remote from said network access device comprises a server.

75. The method of claim 74 wherein said server comprises a merchant server.

76. The method of claim 74 wherein said processor is remote from said server.

77. A system for providing a payment service including:
first means for generating a payment service request having independent identification information and a pair of ATM network compatible PINs;
second means for validating said independent identification information;
third means for generating an ATM network transaction message containing at least a selected one of said pair of ATM network compatible PINs based at least in part on said validation; and
fourth means for forwarding said ATM network transaction message to a financial institution over an ATM network for payment.

78. The system of claim 77 further including:
fifth means for storing data and interacting with a network access device; said data storage means having said pair of ATM network compatible PINs stored thereon;
wherein each one of said pair of ATM network compatible PINs is independently encrypted and different from one another.

79. The system of claim 78 wherein said financial institution authorizes payment to a payee.

80. The system of claim 79 wherein said payment service request further includes an amount.

81. The system of claim 80 wherein said payment service request further includes an amount.

82. The system of claim 77 wherein said independent identification information comprises an electronic personal identification number.

83. The system of claim 77 wherein said second means is further configured to validate said independent identification information by:
providing an independent identification information offset;
providing a transaction identifier representing an account number; wherein said transaction identifier does not represent said user's account number;
combining said user identification information and said offset to validate said user; and
associating said user identification information and said offset with said transaction identifier to validate a user.

84. The system of claim 83 wherein said second means is further configured to validate said independent identification information by:
providing an independent identification information offset;
providing a transaction identifier representing an account number; wherein said transaction identifier does not represent said user's account number;
combining said user identification information and said offset to validate said user; and
associating said user identification information and said offset with said transaction identifier to validate a user.

85. The system of claim 85 wherein based at least in part on said second means validation said ATM network transaction message includes a valid ATM network compatible PIN.

85. The system of claim 85 wherein based at least in part on said second means validation said ATM network transaction message includes an invalid ATM network compatible PIN.

87. The system of claim 77 wherein said payment service request further includes a payee.

88. The system of claim 77 further including an input means for inputting said independent identification information at a network access device.

89. The system of claim 83 further including an input means for inputting said independent identification information at a network access device.

90. The system of claim 83 wherein said electronic personal identification number comprises a number other than a user's ATM network compatible PIN.
